(19) United States
(12) Patent Application Publication
(10) Pub. No.: US 2026/0110890 A1
(43) Pub. Date: Apr. 23, 2026

(54) APOCHROMATIC OBJECTIVE

(71) Applicant: Carl Zeiss Microscopy GmbH, Jena (DE)

(72) Inventors: Yueqian Zhang, Jena (DE); Renhu SHI, Göttingen (DE)

(21) Appl. No.: 19/360,865

(22) Filed: Oct. 16, 2025

(30) Foreign Application Priority Data
Oct. 21, 2024 (DE) 10 2024 210 167.2

(51) Int. Cl. G02B 21/02; G02B 7/02; G02B 27/00

(52) U.S. Cl. CPC G02B 21/02; G02B 7/025; G02B 27/005

(57) ABSTRACT

An apochromatic microscope objective can have a relatively large field of view, a relatively high resolution and a relatively good chromatic correction.

### CROSS-REFERENCE TO RELATED APPLICATIONS

This application claims benefit under 35 U.S.C. § 119 to German Application No. 10 2024 210 167.2, filed Oct. 21, 2024. The entire disclosure of this application is incorporated by reference herein.

### FIELD

The disclosure relates to an apochromatic microscope objective. The disclosure also relates to an optical system for a microscope. In addition, the disclosure relates to a microscope.

### BACKGROUND

A multiplicity of different microscope objectives are known. For specific situations and/or applications, it may be desirable to have available an objective with a large field of view, high resolution and good chromatic correction. Objectives are known from WO 2023/120 104 A1, WO 2023/095 723 A1 and US 2023/0185055 A1, for example.

### SUMMARY

There is a desire to further improve corresponding objectives, for example in view of the chromatic correction.

This issue is addressed by a microscope objective according to the present disclosure. Hereinafter, the microscope objective will also be referred to simply as objective.

For example the objective according to the disclosure can have a relatively high resolution over a relatively large field of view and relatively good chromatic correction.

The field of view is also referred to as object field.

According to an aspect of the disclosure, the objective comprises a diverging lens made of a material with an Abbe number (vd) of at least 75, such as at least 80, for example at least 85, for example at least 90, for example at least 95. The diverging lens thus has a relatively low dispersion. It is also referred to as virtually dispersion free.

For example, the diverging lens can be made of a material with a low refractive index. For example, the material of the diverging lens can have a refractive index nd of at most 1.5, such as at most 1.45.

It was found that the use of such a lens enables an objective design that leads to an objective with relatively good chromatic correction.

For example, an objective can be used for multiphoton microscopy and/or for fluorescence microscopy. The features of an objective can be manifested particularly well here.

An objective may take the form of a dry objective or an immersion objective.

For example, it may be an infinity-corrected objective.

In general, an objective comprises a first lens group with positive refractive power, a second lens group with negative refractive power and a third lens group with positive refractive power.

In this case, the lens groups are enumerated in the direction from the object field to the image field for example. For example, the lens groups are arranged successively, such as directly successively. For example, the objective may consist of the three lens groups. It does not have any further lenses in this case.

A lens group should be understood to mean an arrangement of one or more lenses.

According to an aspect, the objective is apochromatically corrected over a conventional apochromatic spectral range.

In this context, the conventional apochromatic spectral range is understood to mean the range from 435 nm to 656 nm.

Apochromatically corrected is understood to mean that the chromatic aberration is at most as big as the focal depth, such as at most as big as 0.8 times the focal depth, for example at most as big as 0.6 times the focal depth. For example, the e line (546.07 nm) serves as the reference wavelength in this case.

The focal depth just corresponds to half a Rayleigh length (0.5 RU).

In the present case, the chromatic aberration is the axial chromatic aberration for example.

For example, the objective may have a flattened field of view with a diameter of at least 8 mm, such as at least 10 mm.

In this context, a flattened field of view (fFOV) is understood to mean the largest field dimension within which a focal deviation from the axial focus is at most as big as the focal depth, i.e. at most half a Rayleigh length.

A diverging lens is a lens with negative refractive power. It is thus also referred to as a negative lens.

The diverging lens made of the material with the high Abbe number (vd) may for example form the second lens in the beam path of the objective.

The objective has a high resolution. For example, it may have a numerical aperture (NA) of at least 0.09, such as at least 0.1, for example at least 0.11.

According to a further aspect, the product of numerical aperture (NA) of the objective and the diameter (Obj) of the flattened field of view may be at least 1 mm, such as at least 1.1 mm.

For example, the objective has little field curvature.

According to a further aspect, the first lens group (G1) may take the form of a singlet lens.

For example, the objective has a relatively simple structure.

According to a further aspect, the second lens group (G2) may take the form of a singlet lens.

For example, the objective has a relatively simple structure.

For example, the singlet lens of the second lens group (G2) may be the diverging lens with the low dispersion.

According to a further aspect, the third lens group (G3) may comprise four lenses. For example, it may comprise two cemented members, for example 2 cemented doublets. For example, the third lens group may consist of 2 cemented doublets.

For example, the objective can consist of at most 10, such as at most 8, for example at most 7, for example at most 6 lenses.

For example, the objective has a particularly simple structure. For example, it is producible in cost-effective fashion.

According to a further aspect, the objective has a magnification of at most 5 times, such as at most 4 times, for example at most 2.5 times.

This may be the nominal magnification specified on the objective. For example, the magnification is achieved in combination with the specified tube system.

According to a further aspect, the diverging lens has a biconcave form.

According to a further aspect, the objective may be apochromatically corrected over an extended apochromatic spectral range.

In this context, an extended apochromatic spectral range is understood to mean the range from 400 nm to 750 nm.

According to a further aspect, the objective may have even better chromatic correction in a smaller spectral range, such as in the range from 530 nm to 660 nm. Over the spectral range from 530 nm to 660 nm, the axial chromatic aberration can be for example at most as big as 0.5 Rayleigh lengths, such as at most as big as 0.3 Rayleigh lengths, for example at most as big as 0.2 Rayleigh lengths.

According to a further aspect, the following may apply to a ratio of a distance (t12) between the first lens group and the second lens group to an overall length of the objective: t12:ta<0.2, such as t12:ta<0.18, for example t12:ta<0.16, for example t12:ta<0.15.

In this case, the overall length ta is measured from the object-side vertex of the first, frontmost lens surface to the image-side vertex of the backmost lens surface of the objective.

The overall length ta of the objective can for example be at most 80 mm, such as at most 60 mm, for example at most 55 mm.

The objective may have a compact structure.

According to a further aspect, the objective may comprise a lens arrangement as per the following design data:

| Surface No. | r (mm) | d (mm) | nd | vd |
|---|---|---|---|---|
| 1 | −1825.754 | 3.80 | 1.883 | 40.76 |
| 2 | −18.625 | 7.57 | | |
| 3 | −19.781 | 3.19 | 1.434 | 95.22 |
| 4 | 18.516 | 22.33 | | |
| 5 | −11.210 | 2.51 | 1.804 | 46.50 |
| 6 | 26.919 | 3.49 | 1.487 | 84.47 |
| 7 | −12.340 | 0.24 | | |
| 8 | 56.402 | 3.67 | 1.434 | 95.22 |
| 9 | −13.970 | 5.51 | 1.847 | 23.78 |
| 10 | −16.785 | | | |

A further issue addressed by the disclosure involves improving an optical system made of a microscope objective and a tube lens unit.

This issue can be addressed by an optical system having an objective according to the description above and a tube lens unit.

A further issue addressed by the disclosure consists of improving a microscope.

This issue can be addressed by a microscope having an objective according to the description above.

For example, the objective allows imaging of a large object field with high resolution and excellent axial chromatic correction. This can be desirable, for example, for multiphoton microscopy and fluorescence microscopy.

For example, the microscope can be a multiphoton microscope or a fluorescence microscope.

### BRIEF DESCRIPTION OF THE DRAWINGS

Further features, details and particulars of the disclosure are evident from the description of exemplary embodiments with reference to the figures, in which:

FIG. 1 schematically shows the structure of a microscope;

FIG. 2 shows a schematic longitudinal section through the lens arrangement of the microscope objective according to one variant;

FIG. 3 schematically shows the axial focal position in Rayleigh units, as a function of the wavelength; and

FIG. 4 schematically shows a longitudinal section through the lens arrangement of a tube lens.

### DETAILED DESCRIPTION

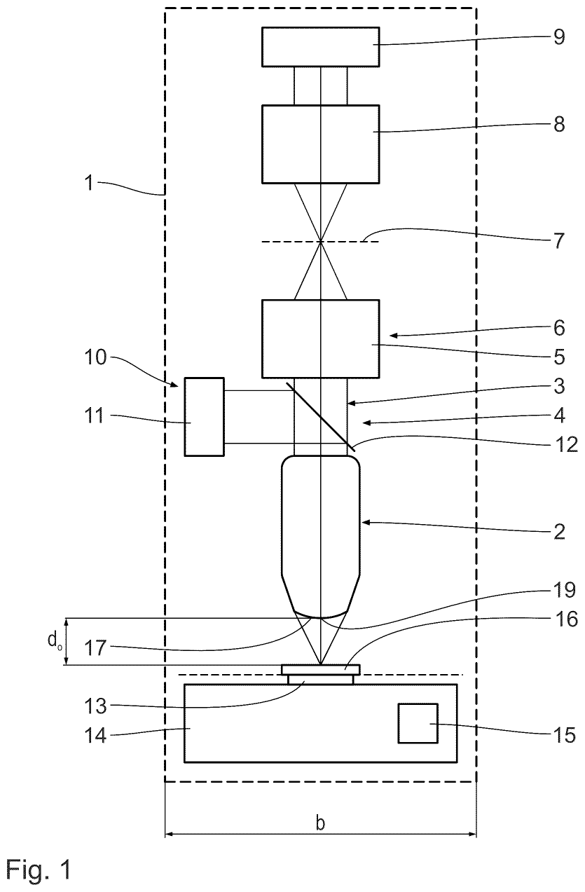

FIG. 1 schematically shows certain structure of a microscope 1 by way of example. The illustration should be understood as an example and not as a limitation.

The microscope 1 comprises infinity-corrected optics. This means that the beam path 3 downstream of the objective 2 runs parallel. The region between the objective 2 and a tube lens 5 of a tube lens unit 6 is also referred to as infinity space 4. By means of the tube lens unit 6, an intermediate image is generated in an intermediate image plane 7. The intermediate image can be viewed using an eyepiece 8. It can also be guided to an image acquisition device, for example in the form of a camera 9. The camera 9 can for example be a digital camera.

FIG. 1 also shows an illumination device 10 as an example. The illumination device 10 comprises a radiation source unit 11. For example, a laser can serve as the radiation source unit 11.

The illumination device 10 may also have a beam splitter 12. By means of the beam splitter 12, the illumination radiation 3 can be guided through the objective 2 to a sample 13 to be viewed. The beam path shown schematically in FIG. 1 is suitable for example for epi-fluorescence systems. The illumination can be in the form of Köhler illumination. Critical illumination is also possible. Instead of the beam splitter 12, a prism, for example a cubic prism, may also be provided. Alternative variants for coupling the illumination radiation are known from the prior art.

A scanning device 14 is also illustrated schematically in FIG. 1. The scanning device 14 comprises one or more displacement devices 15. By means of the displacement devices 15, the sample 13 can be displaced relative to the beam path 3, for example relative to the objective 2, in the microscope 1.

To illustrate the working distance of the objective 2, the distance d from the coverslip 16 to the vertex 19 of the frontmost lens surface 17 of the objective 2 is shown in FIG. 1 as an example.

The distance from an object plane 18 to the vertex 19 of the frontmost lens surface 17 is plotted as do.

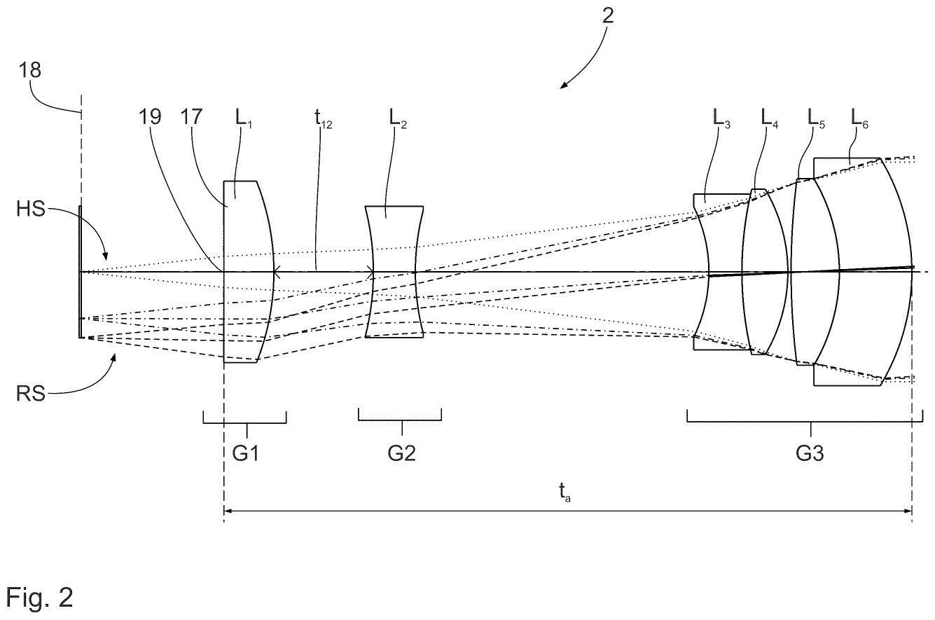

FIG. 2 shows a longitudinal section through the arrangement of the lenses L1 to L6 of the objective 2.

FIG. 2 illustrates by way of example the optical path of a central chief ray HS, of a marginal ray RS and of a further ray (without a label).

For reasons of clarity, mechanical component parts of the objective 2 are not shown in the figure.

The objective 2 is an apochromatic objective 2 for example. For example, the objective 2 is chromatically corrected, for example over a large wavelength range. For example, it is corrected over a conventional apochromatic range, such as over an extended apochromatic range.

The objective 2 according to FIG. 2 comprises six lenses L1 to L6.

The lenses L1 to L6 of the objective 2 are arranged in three groups, G1, G2 and G3.

The first lens group G1 has positive refractive power.

The second lens group G2 has negative refractive power.

The third lens group G3 has positive refractive power.

The first lens group G1 comprises the first lens L1. For example, it may consist of the first lens L1.

The second lens group G2 comprises the second lens L2. For example, it may consist of the second lens L2.

For example, the second lens L2 is a diverging lens, i.e. a lens with negative refractive power.

The lens L2 has a biconcave form.

The lens L2 is made of a material with very low dispersivity. For example, it is made of a material with an Abbe number vd of 95.22.

The lens L2 is made of a material with a low refractive index. For example, it is made of a material with a refractive index nd=1.434.

The third lens group G3 comprises four lenses L3, L4, L5 and L6.

For example, the third lens group G3 comprises a cemented member, for example a cemented doublet. For example, it may comprise two cemented members, for example 2 cemented doublets.

The distance t₁₂ between the first lens group G1 and the second lens group G2, for example the distance between the first lens L1 and the second lens L2, is 7.57 mm.

The distance tₐ between the vertex 19 of the frontmost lens surface 17 and a vertex 20 of a backmost lens surface 21 in the beam path 3 of the objective 2 is 52.31 mm.

Thus, t₁₂:tₐ=0.145 applies.

The optical design data of the objective 2 according to FIG. 2 are collated in Table 1.

TABLE 1
Optical design data of the objective 2 according to FIG. 2:

| Surface No. | r (mm) | d (mm) | nd | vd |
|---|---|---|---|---|
| 1 | −1825.754 | 3.80 | 1.883 | 40.76 |
| 2 | −18.625 | 7.57 | | |
| 3 | −19.781 | 3.19 | 1.434 | 95.22 |
| 4 | 18.516 | 22.33 | | |
| 5 | −11.210 | 2.51 | 1.804 | 46.50 |
| 6 | 26.919 | 3.49 | 1.487 | 84.47 |
| 7 | −12.340 | 0.24 | | |
| 8 | 56.402 | 3.67 | 1.434 | 95.22 |
| 9 | −13.970 | 5.51 | 1.847 | 23.78 |
| 10 | −16.785 | | | |

The statements regarding the refractive index (nd) and the Abbe number (vd) relate to the d-line (587.562 nm).

The objective 2 has a numerical aperture (NA) of 0.11. The objective has a diameter (Obj) of the flattened field of view of 10 mm. The product of numerical aperture (NA) and diameter (Obj) of the flattened field of view is 1.1, NA×Obj=1.1.

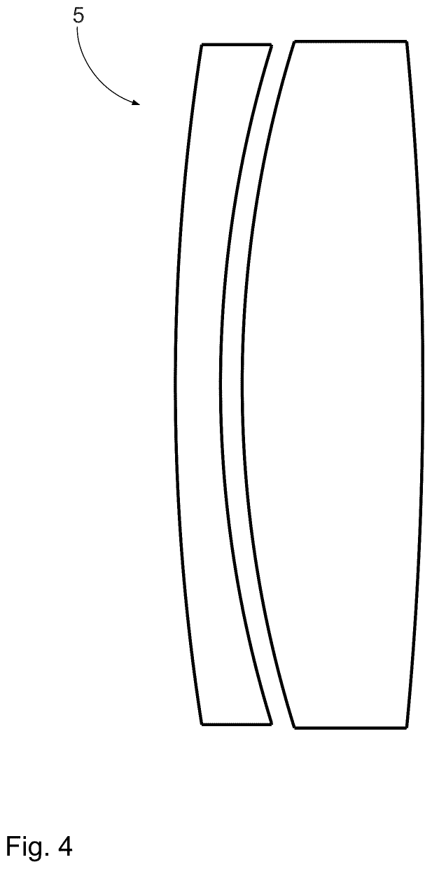

The objective 2 has a magnification of 2.5. This statement relates for example to the use of the objective with the tube lens 5 described below. The optical design data of the tube lens 5 according to FIG. 4 are specified in Table 2.

TABLE 2
Optical design data of the tube lens 5 according to FIG. 4:

| Surface No. | r (mm) | d (mm) | nd | vd |
|---|---|---|---|---|
| 1 | 121.921 | 15.067 | 1.654 | 39.70 |
| 2 | 63.494 | 4.663 | | |
| 3 | 63.861 | 4.416 | 1.488 | 70.41 |
| 4 | −202.192 | 0.154 | | |

The tube lens 5 is a 195 mm tube lens.

The objective 2 is designed for use with a coverslip 16 with a thickness of 0.17 mm, a refractive index nd=1.523 and an Abbe number vd=54.52.

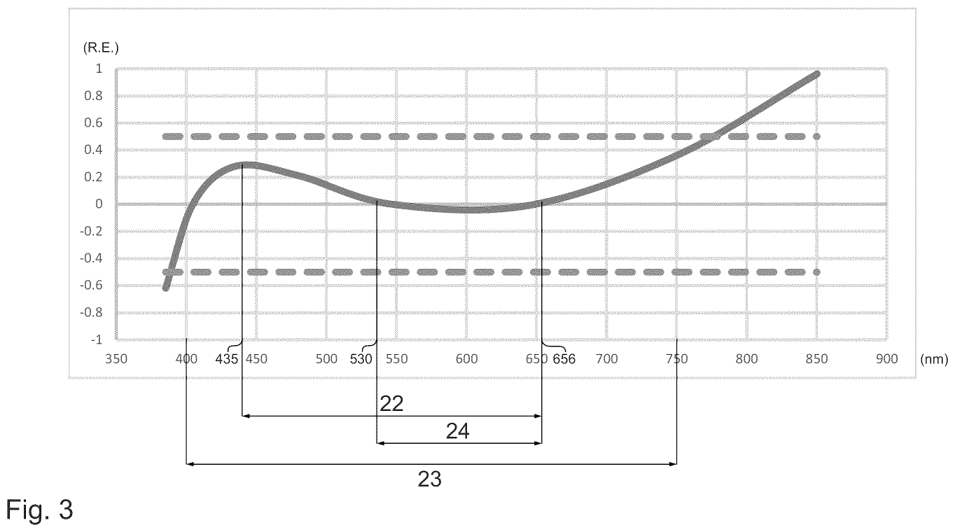

As may be gathered from FIG. 3, the objective 2 has an excellent apochromatic correction in the conventional apochromatic range 22 of 435 nm to 656 nm.

The objective 2 has a good apochromatic correction in the extended apochromatic range 23 of 400 nm to 750 nm.

The objective 2 has a virtually perfect apochromatic correction 24 in a tighter apochromatic range of 530 nm to 656 nm. The maximum axial deviation of the focal position from the focal position of the line (546.07 nm) is for example at most 0.2 Rayleigh units (RU), for example at most 0.1 Rayleigh units.

For example, the objective 2 may have such a good apochromatic correction over a wavelength range of at least 100 nm from the range of 300 nm to 1200 nm, for example from the range of 400 nm to 750 nm, for example from the range up to 700 nm, that the maximal axial variation of the focal position in this range for example is at most 0.2 Rayleigh units (RU), for example at most 0.1 Rayleigh units.

What is claimed is:

1. A microscope objective, comprising:
a first lens group with positive refractive power;
a second lens group with negative refractive power; and
a third lens group with positive refractive power,
wherein:
the microscope objective is apochromatically corrected over a range from 435 nm to 656 nm;
a chromatic aberration is at most as large a focal depth of the microscope objective;
the microscope objective has a flattened field of view with a diameter (Obj);
the microscope objective has a numerical aperture (NA);
$$NA ⋆ Obj > 1 mm ;$$
and
the microscope objective is an apochromatic microscope objective.

2. The microscope objective of claim 1, wherein the second lens group comprises a diverging lens which comprises a material with an Abbe number of at least 75.

3. The microscope objective of claim 2, wherein the diverging lens is biconcave.

4. The microscope objective of claim 1, wherein the numerical aperture (NA) is at least 0.09.

5. The microscope objective of claim 4, wherein the diameter (Obj) of at least 8 mm.

6. The microscope objective of claim 1, wherein the diameter (Obj) of at least 8 mm.

7. The microscope objective of claim 1, wherein the first lens group comprises a singlet lens.

8. The microscope objective of claim 1, wherein the second lens group comprises a singlet lens.

9. The microscope objective of claim 1, wherein the third lens group comprises two cemented elements.

10. The microscope objective of claim 1, wherein:
the first lens group comprises a singlet lens;
the second lens group comprises a singlet lens; and
the third lens group comprises two cemented elements.

11. The microscope objective of claim 10, wherein the numerical aperture (NA) is at least 0.09, and the diameter (Obj) of at least 8 mm.

12. The microscope objective of claim 10, wherein the second lens group comprises a diverging lens which comprises a material with an Abbe number of at least 75.

13. The microscope objective of claim 10, wherein the microscope objective has a magnification of at most 5 times.

14. The microscope objective of claim 10, wherein the microscope objective has following optical design data:

| Surface No. | r (mm) | d (mm) | nd | vd |
|---|---|---|---|---|
| 1 | −1825.754 | 3.80 | 1.883 | 40.76 |
| 2 | −18.625 | 7.57 | | |
| 3 | −19.781 | 3.19 | 1.434 | 95.22 |
| 4 | 18.516 | 22.33 | | |
| 5 | −11.210 | 2.51 | 1.804 | 46.50 |
| 6 | 26.919 | 3.49 | 1.487 | 84.47 |
| 7 | −12.340 | 0.24 | | |
| 8 | 56.402 | 3.67 | 1.434 | 95.22 |
| 9 | −13.970 | 5.51 | 1.847 | 23.78 |
| 10 | −16.785 | | | |

15. The microscope objective of claim 1, wherein the microscope objective has a magnification of at most 5 times.

16. The microscope objective of claim 1, wherein the microscope objective is apochromatically corrected over an extended apochromatic spectral range.

17. The microscope objective of claim 1, wherein the following applies to a ratio of a distance (t12) between the first lens group and the second lens group to an overall length (ta) of the microscope objective: t₁₂:tₐ<0.2.

18. The microscope objective of claim 1, wherein the microscope objective has following optical design data:

| Surface No. | r (mm) | d (mm) | nd | vd |
|---|---|---|---|---|
| 1 | −1825.754 | 3.80 | 1.883 | 40.76 |
| 2 | −18.625 | 7.57 | | |
| 3 | −19.781 | 3.19 | 1.434 | 95.22 |
| 4 | 18.516 | 22.33 | | |
| 5 | −11.210 | 2.51 | 1.804 | 46.50 |
| 6 | 26.919 | 3.49 | 1.487 | 84.47 |
| 7 | −12.340 | 0.24 | | |
| 8 | 56.402 | 3.67 | 1.434 | 95.22 |
| 9 | −13.970 | 5.51 | 1.847 | 23.78 |
| 10 | −16.785 | | | |

19. An optical system, comprising
a microscope objective according to claim 1; and
a tube lens unit.

20. A microscope, comprising:
a microscope objective according to claim 1.
